(19) United States
(12) Patent Application Publication
(10) Pub. No.: US 2011/0203283 A1
(43) Pub. Date: Aug. 25, 2011

(54) Burner arrangement

(76) Inventors: Andreas Böttcher, Mettmann (DE); Tobias Krieger, Duisburg (DE); Daniel Vogtmann, Monheim (DE); Ulrich Wörz, Oviedo, FL (US)

(21) Appl. No.: 13/029,352

(22) Filed: Feb. 17, 2011

(30) Foreign Application Priority Data
Feb. 19, 2010 (EP) 10154109.2

(51) Int. Cl. F23R 3/28; F02M 61/00

(52) U.S. Cl. 60/737; 239/533.2

(57) ABSTRACT

A burner arrangement is provided. The burner arrangement includes a support as well as at least two fuel nozzles, with fuel nozzle tips, attached to the support in the direction of flow and a gas feed system to the fuel nozzle tips extending through the support. Each fuel nozzle includes a support-side section which on the support side includes a contact surface with which the fuel nozzle rests on a supporting surface of the support, at least two fuel nozzle tips formed in one piece running from the support-side section in the direction of flow, the gas feed system including at least one gas feed line and its lead-through through the support, the lead-through being embodied as a fit.

### CROSS REFERENCE TO RELATED APPLICATIONS

This application claims priority of European Patent Office application No. 10154109.2 EP filed Feb. 19, 2010, which is incorporated by reference herein in its entirety.

### FIELD OF INVENTION

The present invention relates to a burner arrangement and a gas turbine with such a burner arrangement.

### BACKGROUND OF INVENTION

Essential component parts of a gas turbine include a compressor, a turbine with rotor blades and at least one combustion chamber. The rotor blades of the turbine are arranged as rotor blade rings on a shaft which in the main extends through the entire gas turbine, and is connected to a consumer load, for instance a generator for power generation. The shaft provided with the rotor blades is also called a (turbine) rotor. Between the rotor blade rings are guide vane rings, which act as nozzles to conduct the working medium through the turbine.

During operation of the gas turbine compressed air from the compressor is fed to the combustion chamber. The compressed air is mixed with a fuel, for example oil or gas, and the mixture is combusted in the combustion chamber. The hot combustion exhaust gases are eventually fed to the turbine as a working medium via a combustion chamber outlet, where they expand and cool and transfer pulse to the rotor blades, and thus perform work. The guide vanes are in this case used to optimize the transmission of pulse.

A typical burner arrangement for gas turbines, as described in U.S. Pat. No. 6,082,111 and as is used in particular in so-called pipe combustion chambers, generally has an annular support with a number of fuel nozzles distributed evenly around the circumference of the ring. Fuel nozzle openings are arranged in these fuel nozzles, with which fuel can be injected into an air inlet channel. The fuel nozzles represent a main stage of the burner, which serves to generate a premixed flame, in other words a flame in which the air and the fuel are mixed before ignition. To minimize the formation of NOₓ in the flame, premix burners are operated with lean air-fuel mixtures, in other words with mixtures which contain relatively little fuel.

Through the center of the annular fuel distribution ring typically extends a pilot burner, which is embodied as a diffusion burner, i.e. it generates a flame in which the fuel is injected directly into the flame, without first being mixed with air. Apart from starting up the gas turbine, the pilot burner also serves to stabilize the premixed flame, which to minimize the emission of pollutants is frequently operated in a range of the air-fuel ratio which without an auxiliary pilot flame could result in flame instabilities.

A burner arrangement such as the described burner arrangement typically has a number of fuel nozzles machined out of a metal block and welded to the support for feeding fuel to the combustion chamber. The support in this case distributes the fuel to the individual nozzles through built-in fuel passages (distribution channels).

To be able to provide enough space for machining the fuel passages, the support blank and thus the subsequent support must be of a certain minimum thickness. This increases the weight of the burner arrangement as well as the material costs. Machining is additionally very labor-intensive.

Moreover, in operation the support heats up, but the fuel-conducting lines remain cold. As a result thermal strains arise and the support does not satisfy the requirement for a long service life.

### SUMMARY OF INVENTION

It is thus the object of the present invention to provide an advantageous burner arrangement, in particular an advantageous burner arrangement for gas turbines, which satisfies the necessary service life requirements. It is a further object to provide an advantageous gas turbine with such a burner arrangement.

This object is achieved by a burner arrangement as claimed in the claims. The object in respect of the gas turbine is achieved by the specification of a gas turbine as claimed in the claims. The dependent claims contain advantageous embodiments of the invention.

The inventive burner arrangement includes a support and a number of fuel nozzles, which are mounted on the support in the direction of flow. It has been found that if the support is used as a fuel distributor it must have a minimum height, i.e. a certain thickness. Since the support embodied as a fuel distributor is exposed directly to the hot gas in the combustion chamber, it must consist of a high-temperature-resistant material, e.g. a super alloy. These are however very expensive.

According to the invention a burner arrangement hence has a support and at least two fuel nozzles, with fuel nozzle tips, attached to the support in the direction of flow. In this case each fuel nozzle includes a support-side section, which on the support side has a contact surface with which it rests on a supporting surface of the support, with at least two fuel nozzle tips, formed in one piece, running from the support-side section in the direction of flow. Moreover the inventive burner arrangement has a gas feed system, extending through the support, to the fuel nozzle tips. According to the invention the gas feed system includes at least one gas feed line and its lead-through through the support. According to the invention the lead-through is now embodied as a fit. This can in particular be a dimension fit or transition fit.

Thus a distribution channel in the support can be dispensed with. As a result the material strength of the support can be reduced, as a result of which weight and costs are saved. Additionally the demands on the installation space for the burner arrangement in the region of the side of the support facing away from the fuel nozzles are less stringent compared to the prior art. Overall the machining of the support is also simplified.

The gas feed system includes at least one gas feed line and its lead-through through the support. However, since the gas feed line for the most part remains cold in operation as a result of the gas flowing through and the support heats up as a result of the compressor air, this produces thermal strains which do not guarantee a sufficient service life. This is in particular the case if the gas feed line is connected to the support in material bonded manner, e.g. welded to it, in order for example to produce a seal for the lead-through. If the fuel nozzle is additionally attached to the support by screws this also creates a dual anchorage, which likewise has the effect of reducing the service life.

The lead-through is now embodied as a fit instead of a welding. This can in particular be a dimension fit or transition fit.

“Fit” here refers to a connection of two intermeshed parts, with both parts having the same nominal dimension, but where the position and size of the tolerance fields can be different. A fit always indicates a tolerance within which the actual dimensions of bored hole and shaft may vary.

Either a clearance fit or an interference fit results on the manufactured component. Where the tolerances permit both a clearance and an interference, this is known as a transition fit, which depending on the dimensions manufactured in production falls into one of the first groups mentioned above.

The lead-through of the gas feed line through the support is hence embodied in particular as such a fit and thus additionally peimits only a small flow (compressor air or gas leakage too). Because the welding seam has been omitted the support is now free to expand thermally. The service life requirements can thus be satisfied. Moreover, as a result of the inventive fit it is possible to disconnect the fuel nozzles non-destructively.

A further problem of the fuel nozzle in the prior art is the fixing of the fuel nozzles to the support, since the burner nozzles must be arranged perpendicular to the support during the manufacturing process.

According to the invention the fuel nozzles can now be centered over the gas feed line, so that no longer is any increased complexity required here.

Preferably at least one distribution channel is provided remote from the support, and supplies the gas feed line with gas. Since the distribution channels are now remote from the support and—unlike the original distribution channel—are not in direct contact with hot gas, the distribution channels can now be manufactured from a less expensive material. As a result a significant cost saving can be achieved. This means that the fuel is already distributed upstream (viewed in the in direction of flow) of the support and is not split between the channels downstream of the support.

Preferably a further fuel feed line is provided for liquid fuel through the support, in particular an oil line, which supplies the fuel nozzle on the support side with liquid fuel, in particular oil. Thus the fuel nozzle is supplied with gas and oil.

In a preferred embodiment at least one seal is present between the support-side contact surface and the support. Preferably the seal is arranged on the support side in the region of the fit and gas feed pipe, in other words the gas pipe. The at least one seal can in this case be embodied as a C-ring seal. In this case the support can have an indentation in which the seal is arranged.

As a result of the fit and the additional seal, in particular the sealing ring, leakproofness against the passage of air is ensured.

Preferably the support-side contact surface of the fuel nozzle has at least one opening for an attachment of the support-side contact surface to the supporting surface of the support. In a preferred embodiment the opening is a bored hole and the attachment is a screw connection or a bolt connection. Preferably six bored holes are provided in the support-side contact surface for screw or bolt connections, the bored holes being distributed over the entire support-side contact surface of the fuel nozzle. As a result of the distribution pattern of the bored holes over the entire contact surface the fuel nozzle has high natural frequencies which can quickly be attenuated. Thus the fuel nozzle is stable in the face of natural frequencies.

The inventive gas turbine includes a compressor section, a combustion section, a combustion chamber, a burner, a turbine section, a rotor and such a burner arrangement. As a result the gas turbine is embodied particularly easily.

### BRIEF DESCRIPTION OF THE DRAWINGS

Further features, attributes and advantages of the present invention emerge from the following description of exemplary embodiments with reference to the attached figures.

FIG. 1 shows a gas turbine in a highly diagrammatic illustration.

FIG. 2 shows a gas turbine burner arrangement according to the prior art in a perspective illustration.

FIG. 3 shows an inventive burner arrangement from the front.

FIG. 4 shows a cross-section through a part of the inventive burner arrangement.

### DETAILED DESCRIPTION OF INVENTION

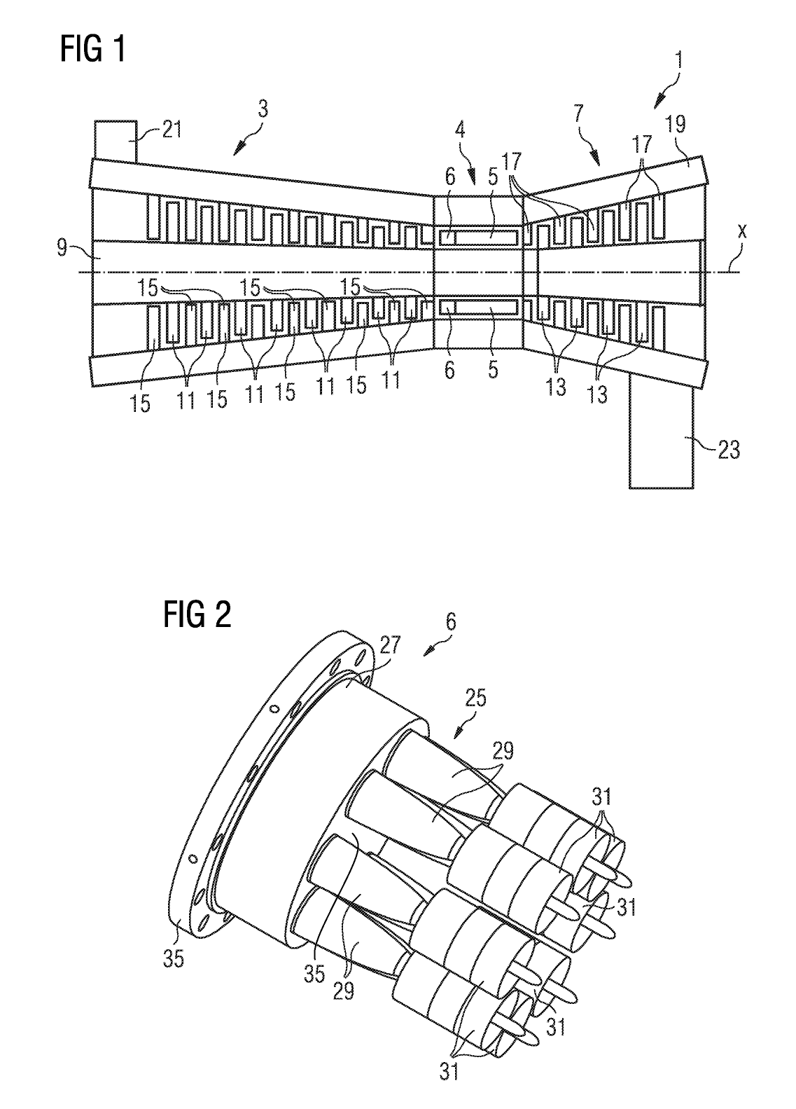

The structure and function of a gas turbine are explained below on the basis of FIG. 1, which shows a highly diagrammatic sectional view of a gas turbine. The gas turbine 1 includes a compressor section 3, a combustion section 4 which in the present exemplary embodiment includes a plurality of pipe combustion chambers 5 with burners 6 arranged thereon, but which can fundamentally also include an annular combustion chamber, and a turbine section 7. A rotor 9 extends through all sections and in the compressor section 3 supports compressor blade rings 11 and in the turbine section 7 turbine blade rings 13. Rings composed of compressor guide vanes 15 or rings composed of turbine guide vanes 17 are arranged between adjacent compressor blade rings 11 and between adjacent turbine blade rings 13, said rings extending out radially from a housing 19 of the gas turbine 1 in the direction of the rotor 9.

During operation of the gas turbine 1 air is sucked in through an air inlet 21 into the compressor section 3. There the air is compressed by the rotating compressor blades 11 and is fed to the burners 6 in the combustion section 4. In the burners 6 the air is mixed with a gaseous or liquid fuel and the mixture is combusted in the combustion chambers 5. The hot combustion exhaust gases, which are under high pressure, are then fed to the turbine section 7 as a working medium. On their way through the turbine section the combustion exhaust gases transfer a pulse to the turbine blades 13, whereby they expand and cool. Finally the expanded and cooled combustion exhaust gases leave the turbine section 7 through an exhaust 23. The transferred pulse results in a rotational movement of the rotor, which drives the compressor and a consumer load, for example a generator for generating electrical power or a production machine. The rings of turbine guide vanes 17 in this case serve as nozzles for conducting the working medium, in order to optimize the transmission of pulse to the turbine rotors 13.

FIG. 2 shows a burner 6, known from the prior art, of the combustion section 4 in a perspective illustration. The main components of the burner 6 are a fuel distribution ring 27, eight fuel nozzles 29 which extend out from the fuel distribution ring 27, and eight spin generators 31 arranged in the region of the tips of the fuel nozzles 29. The fuel distribution ring 27 and the fuel nozzles 29 together form a burner housing, through which fuel lines extend to injection openings which are arranged within the spin generator 31. The fuel nozzles 29 can be welded to the fuel distribution ring 27. The burner can be connected to fuel feed lines via a number of pipe sockets (not shown). The burner 6 can be attached to a pipe combustion chamber by means of a flange 35 such that the fuel nozzles 29 point to the interior of the combustion chamber.

Although the burner 6 shown in FIG. 2 has eight fuel nozzles 29, it is also possible to equip it with a different number of fuel nozzles 29. The number of fuel nozzles 29 can in this case be larger or smaller than eight, for example six fuel nozzles 29 or twelve fuel nozzles 29 can be present, which each have their own spin generator. Furthermore a pilot fuel nozzle is generally arranged in the center of the burner. The pilot fuel nozzle is not shown in FIG. 2 for the sake of clarity.

In the combustion process, air is fed from the compressor through the spin generator 31, where it is mixed with fuel. The air-fuel mixture is then combusted in the combustion zone of the combustion chamber 5 in order to form the working medium.

The role of the support 27 is to distribute the fuel to the fuel nozzles 29. To this end it has fuel channels inside it, each of which supplies a number of nozzles 29 with fuel. Two connectors are present on the support 27 for fuel feed lines, which conduct the fuel to the support 27, in which it is then distributed to the fuel nozzles 29. Different types of fuel can also be used in this case. To this end the fuel nozzles 29 have at least one fuel opening at which the fuel can escape.

In the burner arrangements currently known (FIG. 2) the channels are typically milled by machine into a cylindrical support blank and then covered with welded-on elements. Likewise the lead-throughs for the pipelines are machined into the support blank. In order to provide enough space for machining the lead-throughs and the gas passages, the support blank and thus the subsequent support must have a certain minimum thickness. This increases the weight of the burner arrangement as well as the material costs. Machining is also labor-intensive and consequently is associated with high costs. Another problem is manufacturing the fuel nozzles 29 onto the support 27, since the burner nozzles 29 must be welded perpendicular to the support 27. This manufacturing is moreover very protracted and is associated with increased complexity and thus costs. The fuel nozzles are also welded to the spin generator 31. The support 27 is exposed to high temperatures, as are the fuel nozzles 29. Hence supports 27 and also fuel nozzles 29 must be manufactured from a high-temperature-resistant material, e.g. corrosion-resistant nickel base alloys. However, this material likewise drives costs up steeply.

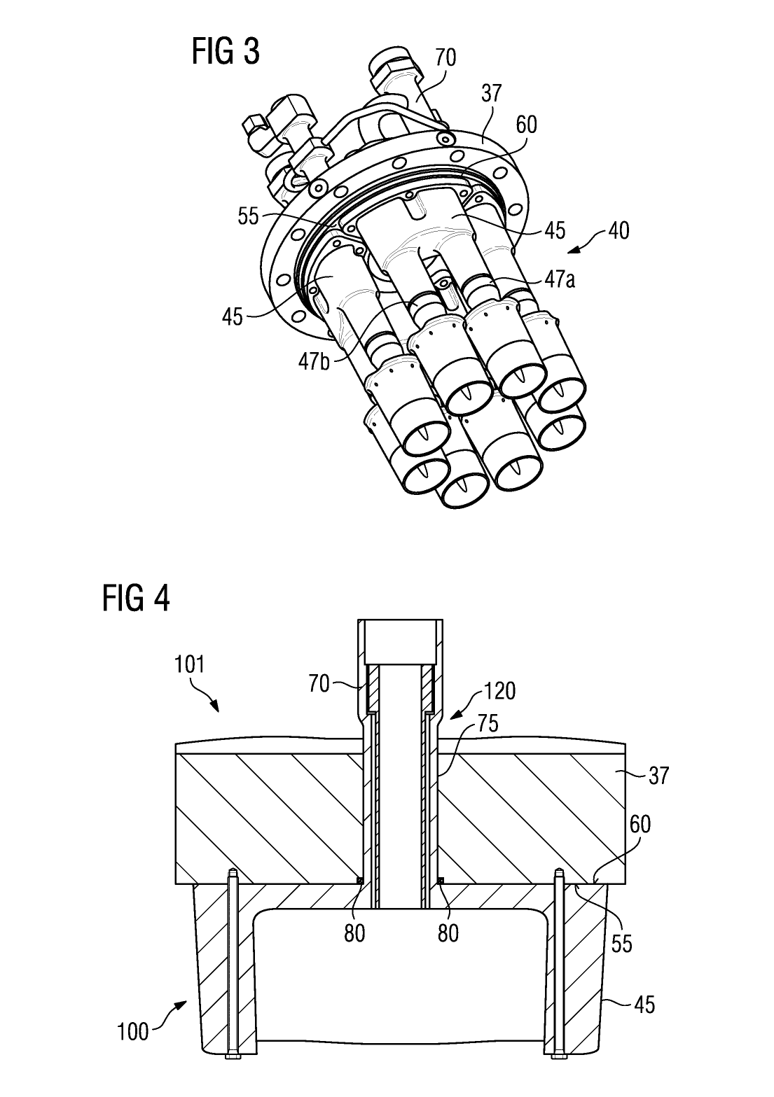

This is thus avoided with the aid of the invention (FIG. 3 and FIG. 4). According to the invention a burner arrangement with a support 37 and at least two fuel nozzles 40 attached to the support 37 in the direction of flow is provided. In this case each fuel nozzle 40 has a support-side section 45 which on the support side 100 has a contact surface 60, with which it rests on a supporting surface 55 of the support 37. At least two fuel nozzle tips 47a, 47b formed in one piece run from the support-side section 45 in the direction of flow, in other words in the direction of the combustion chamber 5.

The fuel nozzle 40 has a gas feed system 120 which extends through the support 37 and which transports gas to the fuel nozzle tips 47a, 47b.

In this case the gas feed system 120 includes at least one gas feed line 70, mainly in the form of a gas pipe 70 and its lead-through through the support 37. In this case the lead-through can be a bored hole.

In this case the lead-through, in particular the bored hole, is embodied as a fit 75.

The lead-through of the gas pipe 70 is hence inventively embodied as a fit 75 and thus allows little flow, e.g. compressor air inflow or gas outflow. This is in particular a dimension fit or transition fit. As a result of the fit the support 37 can thus expand freely in operation. Thermal strains are thus removed or are greatly reduced, resulting in an increase in the service life.

According to the invention the gas pipe 70 for the most part remains cold in operation, whereas however the support 37 heats up. In this case the support 37 expands. If the gas pipe 70 is welded to the support 37 as in the prior art for the purpose of sealing, large strains can arise in the welded area as a result of the thermal expansions. Thus where welding occurs the service life requirements are not satisfied as a result of the different expansion of the support 37 and of the gas pipe 70. If additionally the fuel nozzle 40 is still screwed to the support 37, the attachment of the fuel nozzle 40 to the support 37 is overdefined by the welding and the screw connection, which likewise has a negative impact on the service life.

To prevent the fit 75 for the gas pipe 70 forming undesired passages for gas or compressor air of the turbine, preferably at least one seal 80 is present at the support-side 100 end of the fit 75, in particular in the region of the fit 75 and the gas pipe 70. In this case the support 37 can have an indentation in which the seal 80 is arranged. Such a seal 80 can in particular be embodied as a C-ring seal. These are particularly well suited as seals because of their resilience attributes. However, other spring-elastic seals such as O-ring seals are also possible. Because of the elasticity of the seal excessive restrictions on relative movements, which for example could arise because of the heating of the components during operation, can be prevented.

A further problem with the fuel nozzle in the prior art is the manufacture of the fuel nozzles 40 onto the support 37, since the fuel nozzles 40 must be arranged perpendicular to the support 37 during the manufacturing process. Moreover this manufacturing process is very protracted and is associated with increased complexity and consequently costs.

However, the invention thus easily enables the fuel nozzle 40 to be centered, in particular as a result of the fit 75, over the gas pipe 70, so that no longer is any increased complexity necessary here.

Further through-holes (not shown separately) can be arranged in the support 37, through which additionally at least one oil channel can be routed through the support 37.

Remote from the support 101 at least one distribution channel (not shown) is provided, but in the main two distribution channels respectively for oil and gas, which supply the gas supply pipe 70 and the at least one oil channel respectively with the corresponding fuel while still remote from the support 101. Since the distribution channels do not come into direct contact with the hot gas in the combustion chamber, they can be manufactured from an inexpensive material.

Additionally the demands on the installation space of the burner arrangement in the region of the side of the support facing away from the fuel nozzles 40 are less stringent compared to the prior art. Overall the machining of the support is also simplified.

The support-side contact surface 60 has bored holes for attaching the fuel nozzles 40 to the support. To this end the support 37 has corresponding openings or bored holes. As a result of these bored holes the fuel nozzle 40 can be attached to the support 37 by means of a screw connection or a bolt connection. In this case the bored holes are distributed across the entire support-side contact surface 60. As a result of this distribution of the bored holes the fuel nozzle 40 has high natural frequencies which can be quickly attenuated. Thus the fuel nozzle 40 is stable in the face of natural frequencies. The screw or bolt connection attaches the fuel nozzle 40 to the support 37 and thus absorbs a large part of the pressure stresses during operation.

The bored holes in the support-side contact surface 60, as well as the corresponding holes/bored holes in the support 37, can be provided with large measuring tolerances, so that quick and simple manufacturing is possible.

Because of the inventive burner arrangement it is possible to significantly increase the service life of the burner arrangement. This is due to the fact that the free thermal deformations which are now possible no longer build up any obstructive heat stresses. The fuel nozzle 40 can easily be centered over the gas pipe 70.

As a result of the C-ring undesired leaks can be prevented; an uncontrolled outflow or inflow of gas and/or compressor air can thus be prevented.

With the inventive burner arrangement the individual fuel nozzles 40 can now be easily and non-destructively disconnected from the support, as a direct result of which assembly/disassembly is improved. This is of enormous advantage; particularly when inspecting systems which have already been manufactured and commissioned.

Because of the inventive burner arrangement it is possible to reduced the costs significantly. This is due to the fact that the fuel distributor 37 is now significantly less thick than the fuel distributor 27 in the prior art. All bored holes or openings can be manufactured quickly and easily, since no particularly precise measuring tolerances are called for or need to be complied with.

1-10. (canceled)

11. A burner arrangement, comprising:
a support;
at least two fuel nozzles, including a plurality of fuel nozzle tips, attached to the support in a direction of flow; and
a gas feed system to the plurality of fuel nozzle tips, which extends through the support,
wherein each fuel nozzle includes a support-side section which includes a contact surface on a support side, with which the fuel nozzle rests on a supporting surface of the support,
wherein the at least two fuel nozzle tips are formed in one piece running from the support-side section in the direction of flow,
wherein the gas feed system includes at least one gas feed line and a lead-through through the support, and
wherein the lead-through is embodied as a fit.

12. The burner arrangement as claimed in claim 11, wherein remote from the support, a distribution channel is provided, which supplies the gas feed line with gas.

13. The burner arrangement as claimed in claim 11, wherein a further fuel feed line for liquid fuel is provided through the support which supplies the fuel nozzle on the support side with liquid fuel.

14. The burner arrangement as claimed in claim 13, wherein the further fuel feed line is an oil line and the liquid fuel is oil.

15. The burner arrangement as claimed in claim 11, wherein a seal is present between the support-side contact surface of the fuel nozzle and the support.

16. The burner arrangement as claimed in claim 15, wherein the seal is arranged on the support side in a region of the fit and the gas feed line.

17. The burner arrangement as claimed in claim 15, wherein the seal is a C-ring seal.

18. The burner arrangement as claimed in claim 11, wherein the support-side contact surface includes an opening for an attachment of the support-side contact surface to the supporting surface of the support.

19. The burner arrangement as claimed in claim 18, wherein the opening is a bored hole and the attachment is a screw connection or a bolt connection.

20. The burner arrangement as claimed in claim 19, wherein six bored holes are provided in the support-side contact surface, the bored holes being distributed across the entire support-side contact surface.

21. A gas turbine, comprising:
a compressor section;
a combustion section;
a combustion chamber;
a burner;
a turbine section;
a rotor; and
a burner arrangement, the burner arrangement, comprising:
a support,
at least two fuel nozzles, including a plurality of fuel nozzle tips, attached to the support in a direction of flow, and
a gas feed system to the plurality of fuel nozzle tips, which extends through the support,
wherein each fuel nozzle includes a support-side section which includes a contact surface on a support side, with which the fuel nozzle rests on a supporting surface of the support,
wherein the at least two fuel nozzle tips are formed in one piece running from the support-side section in the direction of flow,
wherein the gas feed system includes at least one gas feed line and a lead-through through the support, and
wherein the lead-through is embodied as a fit.

22. The gas turbine as claimed in claim 21, wherein remote from the support, a distribution channel is provided, which supplies the gas feed line with gas.

23. The gas turbine as claimed in claim 21, wherein a further fuel feed line for liquid fuel is provided through the support which supplies the fuel nozzle on the support side with liquid fuel.

24. The gas turbine as claimed in claim 23, wherein the further fuel feed line is an oil line and the liquid fuel is oil.

25. The gas turbine as claimed in claim 21, wherein a seal is present between the support-side contact surface of the fuel nozzle and the support.

26. The gas turbine as claimed in claim 25, wherein the seal is arranged on the support side in a region of the fit and the gas feed line.

27. The gas turbine as claimed in claim 25, wherein the seal is a C-ring seal.

28. The gas turbine as claimed in claim 21, wherein the support-side contact surface includes an opening for an attachment of the support-side contact surface to the supporting surface of the support.

29. The gas turbine as claimed in claim 28, wherein the opening is a bored hole and the attachment is a screw connection or a bolt connection.

30. The gas turbine as claimed in claim 29, wherein six bored holes are provided in the support-side contact surface, the bored holes being distributed across the entire support-side contact surface.
